(19) United States
(12) Patent Application Publication
(10) Pub. No.: US 2017/0163072 A1
(43) Pub. Date: Jun. 8, 2017

(54) TERMINAL DEVICE AND CHARGING METHOD THEREOF

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Jianchao CHENG, Beijing (CN)

(21) Appl. No.: 15/244,689

(22) Filed: Aug. 23, 2016

Related U.S. Application Data
(63) Continuation of application No. PCT/CN2016/088698, filed on Jul. 5, 2016.

(30) Foreign Application Priority Data
Dec. 8, 2015 (CN) 201510898089.2

(51) Int. Cl. H02J 7/02; H04M 1/02; H02J 50/90

(52) U.S. Cl. CPC H02J 7/025; H02J 7/027; H02J 50/90; H04M 1/026

(57) ABSTRACT

Disclosed are a terminal device and a charging method thereof. The terminal device includes a charging port disposed on a housing, a controller disposed inside the terminal device, and an induction component and a charging guide component which are disposed at the periphery of the charging port; wherein the induction component is electrically connected with the controller, and is configured to acquire an induction signal between the induction component and a metal joint of a charging cable and send the induction signal to the controller; and the controller is also electrically connected with the charging guide component and is configured to activate the charging guide component when determining that the induction signal meets a first preset condition.

### CROSS-REFERENCES TO RELATED APPLICATIONS

The present disclosure is a continuation application of a PCT application No. PCT/CN2016/088698, filed on Jul. 5, 2016; and claims priority of Chinese Patent Application No. 201510898089.2 entitled “TERMINAL DEVICE AND CHARGING METHOD THEREOF” and filed with the Chinese Patent Office on Dec. 8, 2015, the contents of which are incorporated herein by reference in their entirety.

### TECHNICAL FIELD

The present disclosure relates to the technology of charging a terminal device, for example, relates to a terminal device and a charging method thereof.

### BACKGROUND

As functions of terminal devices such as smart phones become increasingly powerful, the utilization rate of the terminal devices by people is gradually increased as well. The terminal devices have nearly become an essential tool in the people's life.

However, the terminal devices have limited battery capacity and are required to be charged regularly during a using process by a user, therefore, charging the terminal devices becomes a commonly daily behavior, a general manner for charging the terminal devices in the related art is that metal joints of charging cables are manually inserted into charging ports of the terminal devices, but under a low-light source environment or with respect to the population with relatively poor vision, there is a certain degree of difficulty in executing the charging operation.

### SUMMARY

The present disclosure provides a terminal device and a charging method thereof, so as to realize that a metal joint of a charging cable is inserted into a charging port of a terminal device simply and conveniently when the terminal device requires to be charged under a low-light environment or by the population with relatively poor vision.

In a first aspect, an embodiment of the present disclosure provides a terminal device. The terminal device includes a charging port disposed on a housing, a controller disposed inside the terminal device, and an induction component and a charging guide component which are disposed at a periphery of the charging port; wherein

the induction component is electrically connected with the controller, and is configured to acquire an induction signal between the induction component and a metal joint of a charging cable and send the induction signal to the controller; and

the controller is also electrically connected with the charging guide component and is configured to activate the charging guide component when the induction signal meets a first preset condition.

In a second aspect, an embodiment of the present disclosure provides a charging method of a terminal device, including:

acquiring, by the induction component, the induction signal between the induction component and the metal joint of the charging cable, and sending the induction signal to the controller; and

activating, by the controller, the charging guide component when determining that the induction signal meets the first preset condition.

### BRIEF DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram showing the structure of a terminal device according to a first embodiment of the present disclosure;

FIG. 2A is a schematic diagram showing the structure of a terminal device according to a second embodiment of the present disclosure;

FIG. 2B is a schematic diagram showing the structure of another terminal device according to the second embodiment of the present disclosure;

FIG. 3 is a schematic flow diagram of a charging method of a terminal device according to a third embodiment of the present disclosure;

FIG. 4 is a schematic flow diagram of a charging method of a terminal device according to a fourth embodiment of the present disclosure; and

FIG. 5 is a schematic flow diagram of a charging method of a terminal device according to a fifth embodiment of the present disclosure.

### DETAILED DESCRIPTION

The present disclosure will be described in detail below in conjunction with accompanying drawings and embodiments. It should be understood that the embodiments described herein are merely used for explaining the present disclosure, but not limiting the present disclosure. In addition, it is also noted that, for easy of description, relevant structures, rather than all structures, related to the present disclosure are merely shown in the accompanying drawings.

### A First Embodiment

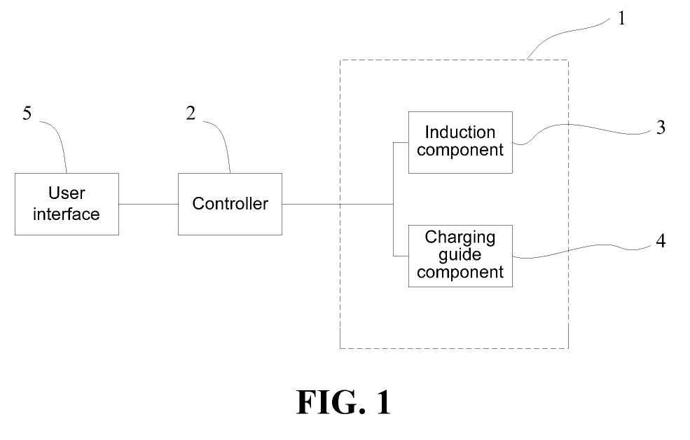

FIG. 1 is a schematic diagram showing the structure of a terminal device according to a first embodiment of the present disclosure, as shown in FIG. 1:

a charging port is disposed on a housing of a terminal device, a controller 2 is disposed inside the terminal device, and an induction component 3 and a charging guide component 4 are disposed at the periphery of the charging port 1.

Wherein the induction component 3 is electrically connected with the controller 2, and is configured to acquire an induction signal between the induction component and a metal joint of a charging cable and send the induction signal to the controller 2; the controller 2 is also electrically connected with the charging guide component 4 and is configured to activate the charging guide component 4 when the induction signal meets a first preset condition, and the charging guide component 4 is configured to guide the metal joint of the charging cable to be inserted into the charging port 1.

A technical solution provided by the first embodiment of the present disclosure, by disposing the controller 2 inside the terminal device and disposing the induction component 3 and the charging guide component 4 at the periphery of the charging port 1, realizes guiding when the metal joint of the charging cable is inserted into the charging port, solves the problem that the metal joint of the charging cable is difficult to be inserted into the charging port of the terminal device when the terminal device is charged in a low-light environment or by a user with relatively poor vision in the related art, and facilitates the completion of the charging.

Optionally, the above controller 2 is further configured to deactivate the charging guide component 4 when the induction signal meets a second preset condition.

Wherein the meeting a first preset condition may mean that a distance between the charging port and the metal joint of the charging cable is less than a first distance threshold, or that the intensity of an induction signal between the induction component and the metal joint of the charging cable is greater than a first induction signal threshold; and the meeting a second preset condition may mean that a distance between the charging port and the metal joint of the charging cable is less than a second distance threshold, or that the intensity of an induction signal between the induction component and the metal joint of the charging cable is greater than a second induction signal threshold, or that the controller receives a signal which indicates that the terminal device is being charged.

On the basis of the above technical solution, wherein the induction component 3 can be optional an electromagnetic induction component or an infrared induction component. Wherein the electromagnetic induction component may be integrated on the inner wall of the charging port 1, the infrared induction component may be integrated at the bottom of the charging port 1 or disposed on the housing at two sides of the charging port 1. These two manners have relatively low cost, the solutions are simply and easily realized, while a precision requirement of the induction signal may be met.

On the basis of the above technical solution, the charging guide component 4 may be an indicator light; and when the induction signal meets the first preset condition, the indicator light is lightened and activated to illuminate the charging port 1 for facilitating inserting the metal joint of the charging cable into the charging port by a user.

On the basis of the above technical solution, the charging guide component 4 may be a magnetic attraction apparatus suitable for a user suffering from vision impairment. When the induction signal meets the first preset condition, the magnetic attraction apparatus is activated, and the metal joint is attracted into the charging port 1 by increasing a magnetic force of an electromagnet at the charging port.

In the technical solution provided by the embodiment of the present disclosure, the charging guide component 4 on the terminal device may include both the indicator light and the magnetic attraction apparatus so as to be selected and used by the user according to an actual condition. Optionally, the above electromagnetic induction component may be reused as the magnetic attraction apparatus.

Optionally, the terminal device provided by the embodiment of the present disclosure may further include a user interface 5 electrically connected with the controller 2 and is configured to receive a mode selection signal input by a user and send the mode selection signal to the controller 2. The controller 2 activates the charging guide component 4 according to the mode selection signal when the induction signal meets the first preset condition, that is, the controller 2 activates the indicator light or the magnetic induction apparatus according to the mode selection signal when the induction signal meets the first preset condition. Optionally, the user interface 5 may serve as a basic setting function of the terminal device, and the user may input the mode selection signal through a touch screen or other input devices when performing basic setting on the terminal device so as to confirm a working mode of the terminal device.

### A Second Embodiment

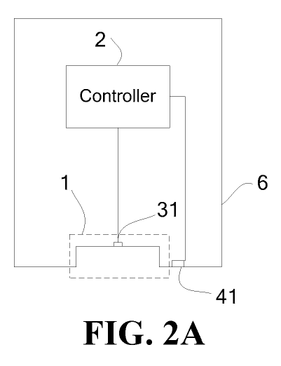

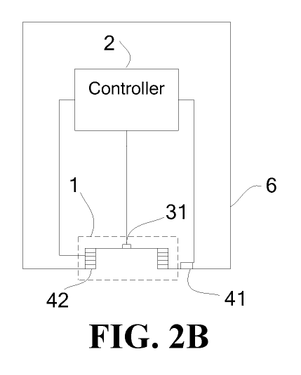

FIG. 2A is a schematic diagram showing the structure of a terminal device according to a second embodiment of the present disclosure, as shown in FIG. 2A, a charging port 1 is positioned at the bottom of a housing of a terminal 6, and an induction component is an infrared sensor 31 disposed at the bottom of the charging port 1. When a metal joint of a charging cable approaches the charging port 1, the infrared sensor 31 sends an infrared induction signal received by the infrared sensor 31 to a controller. When the above infrared induction signal meets a first preset condition, the controller 2 activates an indicator light 41, wherein in the embodiment, the meeting a first preset condition may mean that a distance between the metal joint of the charging cable and the charging port 1 is less than 3 cm, and the controller may control activation of the indicator light 41 when the distance between the metal joint and the charging port 1 is less than 3 cm according to the above infrared induction signal; or the meeting a first preset condition may also mean that the intensity of the induction signal is greater than a certain value, and then the activation of the indicator light 41 is controlled.

In the embodiment, when the indicator light 41 serving as the charging guide component is lightened, the indicator light 41 may not only serve as a position mark of the charging port 1 but also illuminate the peripheral area of the charging port 1, and the indicator light 41 is disposed on a housing at the periphery of the charging port 1. When the controller 2 judges that the distance between the metal joint of the charging cable and the charging port 1 meets a second preset condition, wherein the setting of the second preset condition may refer to that of the above first preset condition, the meeting a second preset condition may mean that the distance between the metal joint of the charging cable and the charging port 1 is less than a certain value, or that the intensity of the induction signal is greater than a certain value, that is, when the controller 2 judges that the metal joint is inserted into the charging port, the indicator light 41 is deactivated, and in addition, may also mean that when a signal indicating that the terminal device is being charged is received, the indicator light 41 is deactivated.

In a solution provided by the second embodiment of the present disclosure, a magnetic attraction apparatus 42 mounted on the inner wall of the charging port 1 is included. As shown in FIG. 2B, FIG. 2B is a schematic diagram showing a structure of another terminal device according to a second embodiment of the present disclosure. The magnetic attraction apparatus 42 may be an induction coil, and the induction coil is disposed around the inner wall of the charging port 1, and may simultaneously serve as the induction component and the charging guide component. When the metal joint of the charging cable approaches the charging port, the magnetic attraction apparatus 42 acquires a magnetic induction signal through electromagnetic induction, and the magnetic attraction apparatus 42 feeds the magnetic induction signal back to a controller 2. When the controller 2 judges whether the first preset condition is met or not according to the induction signal, the first preset condition, for example, may mean that whether the distance between the metal joint of the charging cable and the charging port is smaller than 3 cm or not or whether the intensity of the induction signal is greater than a certain value or not; when the first preset condition is met, the controller 2 will increase a current of the coil in the magnetic attraction apparatus 42, and hence a magnetic field produced by the magnetic attraction apparatus is further increased, and its electromagnetic attraction force is further increased to attract the metal joint of the charging cable into the charging port 1.

In addition, when the controller 2 judges that a distance between the metal joint of the charging cable and the charging port 1 meets a second preset condition, the magnetic attraction apparatus 42 is deactivated. In addition, when the controller receives a signal indicating that the terminal is being charged, the magnetic attraction apparatus 42 can also be deactivated. Wherein the setting of the second preset condition may refer to that of the above preset condition, and the meeting the second preset condition may mean that the distance between the metal joint of the charging cable and the charging port 1 is less than a certain value, or that the intensity of the induction signal is greater than a certain value, that is, when the metal joint is inserted into the charging port, the magnetic attraction apparatus 42 is deactivated In addition, it may also mean that the signal indicating that the terminal device is being charged is received.

In a technical solution provided by the embodiment of the present disclosure, the indicator light 41 may be activated under a low-light environment for positioning and illuminating the charging port 1, thereby facilitating the insertion of the metal joint of the charging cable. When a user suffering from the vision impairment uses it, the metal joint of the charging cable may be attracted into the charging port 1 by the magnetic attraction apparatus 42.

### A Third Embodiment

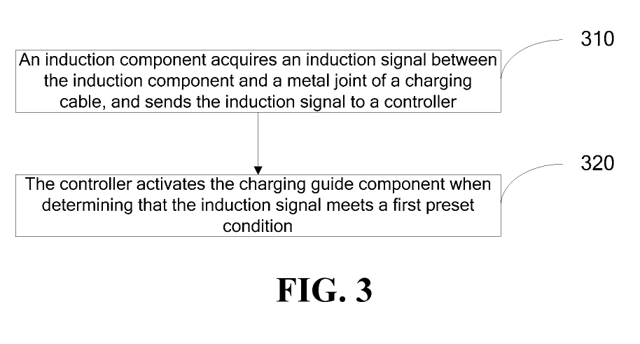

FIG. 3 is a flow diagram of a charging method of a terminal device according to a third embodiment of the present disclosure. Based on the terminal device provided by the above first embodiment and/or the second embodiment, the method is suitable for a case where a user inconveniently inserts a metal joint of a charging cable into a charging port, and may be completed by matching an induction component, a controller and a charging guide component which are disposed on the terminal device.

In Step 310, the induction component acquires an induction signal between the induction component and the metal joint of the charging cable, and sends the induction signal to the controller;

wherein with reference to the technical solution provided by the above embodiments, the induction component may be mounted at the periphery of the charging port; when the metal joint of the charging cable approaches the charging port, the induction component may generate an induction signal and send the generated induction signal to the controller.

In Step 320, the controller activates the charging guide component when determining that the induction signal meets a first preset condition;

wherein the meeting a first preset condition includes a distance between the charging port and the metal joint of the charging cable is less than a first distance threshold, or that the intensity of the induction signal between the induction component and the metal joint of the charging cable is greater than a first induction signal threshold.

A technical solution provided by the third embodiment of the present disclosure realizes, by disposing the controller inside the terminal device and disposing the induction component and the charging guide component at the periphery of the charging port, guiding when the metal joint of the charging cable is inserted into the charging port, and solves the problem that the metal joint of the charging cable is difficult to be inserted into the charging port of the terminal device when the terminal device is charged in the related art, and facilitates the completion of the charging.

### A Fourth Embodiment

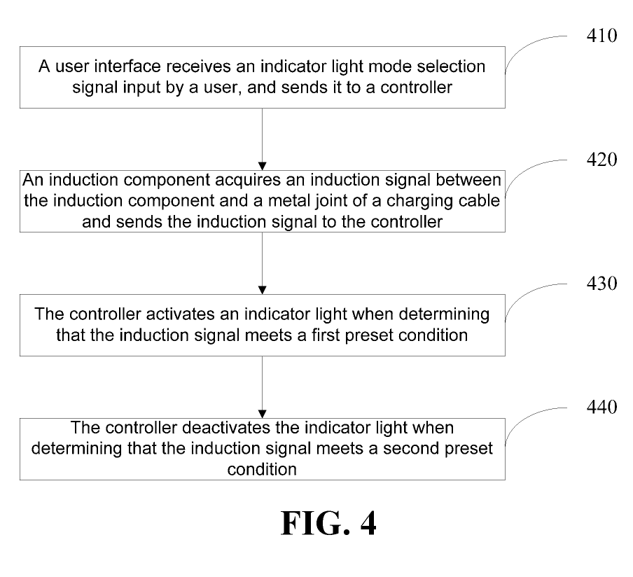

FIG. 4 is a schematic flow diagram of a charging method of a terminal device according to a fourth embodiment of the present disclosure. Based on the terminal device provided by the above embodiment 1 and/or the above embodiment 2, the method is suitable for a case where a user inconveniently inserts a metal joint of a charging cable into a charging port under a low-light environment, and may be completed by matching a user interface, an induction component, a controller and a charging guide component which are disposed on the terminal device. The method includes:

In Step 410, the user interface receives an indicator light mode selection signal input by a user and sends the indicator light mode selection signal to the controller;

wherein the user interface and the controller may be integrated inside a smart phone device, the user interface may set a charging mode according to the self-condition of a user, the user may set the charging mode in advance and may preset the charging mode as an indicator light mode under a low-light environment, for example, when the smart phone device is required to be charged at night.

In Step 420, the induction component acquires an induction signal between the induction component and the metal joint of the charging cable, and sends the induction signal to the controller;

wherein the induction component is mounted at the periphery of the charging port, and acquires a corresponding induction signal when the metal joint of the charging cable approaches the charging port, optionally, the induction component may be various kinds of sensors, for example, an infrared sensor or an electromagnetic induction sensor.

In Step 430, the controller activates the charging guide component when determining that the induction signal meets a first preset condition; and

wherein the meeting a first preset condition may mean that a distance between the charging port and the metal joint of the charging cable is less than a first distance threshold, or that the intensity of the induction signal between the induction component and the metal joint of the charging cable is greater than a first induction signal threshold.

Wherein that the meeting a first preset condition means that a distance between the charging port and the metal joint of the charging cable is less than a first distance threshold may mean that:

the first preset condition includes the distance between the charging port and the metal joint of the charging cable is 3 cm, and the controller activates the charging guide component when the distance between the charging port and the metal joint of the charging cable calculated by the controller is less than 3 cm according to the received induction signal.

Exemplarily, the charging guide component is an indicator light, and activating the charging guide component means that the indicator light is lightened. The indicator light may help a user to position a location of the charging port after being lightened.

Wherein that the meeting a first preset condition means that the intensity of the induction signal between the induction component and the metal joint of the charging cable is greater than a first induction signal threshold may mean that:

when the user is ready for performing a charging operation, the metal joint of the charging cable approaches the charging port, the controller compares the received induction signal with the first induction signal threshold, determines that the user is about to perform a charging operation when the induction signal is greater than the first induction signal threshold, and in this way, activates the charging guide component. Exemplarily, the charging guide component is an indicator light, and activating the charging guide component means that the indicator light is lightened. The indicator light may help the user to position a location of the charging port after being lightened.

In Step 440, the controller deactivates the charging guide component when determining that the induction signal meets a second preset condition;

wherein the meeting a second preset condition may mean that a distance between the charging port and the metal joint of the charging cable is less than a second distance threshold, or that the intensity of the induction signal between the induction component and the metal joint of the charging cable is greater than a second induction signal threshold, or that the controller receives a signal indicating that the terminal device is being charged. When the second preset condition is met, it may be determined that the metal joint of the charging cable has been inserted into the charging port, in this way, the charging guide component may be deactivated, for example, the indicator light is deactivated, so as to reduce power consumption.

A technical solution provided by the fourth embodiment of the present disclosure realizes, by disposing the controller inside the terminal device and disposing the induction component and the charging guide component at the periphery of the charging port, guiding when the metal joint of the charging cable is inserted into the charging port. In addition, by disposing the user interface, the user may select the indicator light mode to work. By setting the second preset condition, the controller deactivates the indicator light when determining that the second preset condition is met according to the induction signal, and thus the power consumption may be reduced.

### A Fifth Embodiment

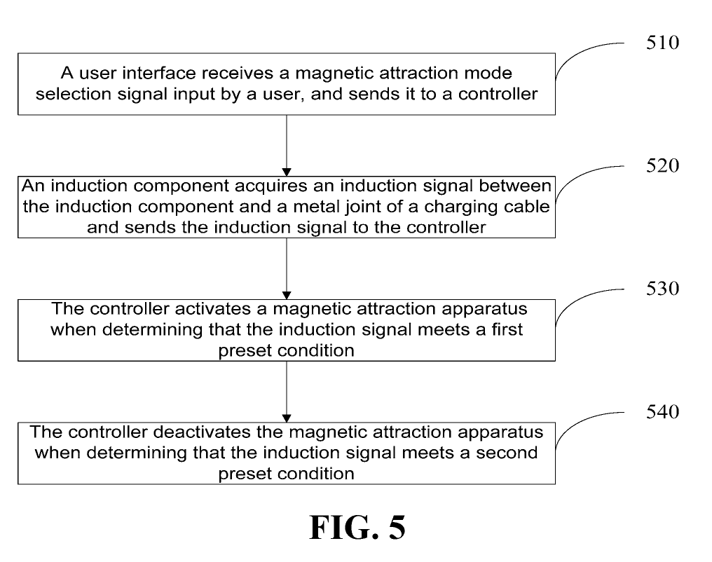

FIG. 5 is a schematic flow diagram of a charging method of a terminal device according to a fifth embodiment of the present disclosure. Based on the terminal device provided by the above first embodiment and/or the above second embodiment, the method is suitable for a case where a user suffering from the vision impairment inconveniently insert a metal joint of a charging cable into a charging port, and may be completed by matching a user interface, an induction component, a controller and a charging guide component which are disposed on the terminal device.

In Step 510, the user interface receives a magnetic attraction mode selection signal input by a user and sends it to the controller;

wherein the user interface and the controller are integrated inside a smart phone device, the user interface may set a charging mode according to a self-condition of the user, and the user may set the charging mode in advance, and may preset the charging mode as a magnetic attraction mode when the user suffering from the vision impairment uses the smart phone device.

In Step 520, the induction component acquires an induction signal between the induction component and the metal joint of the charging cable, and sends the induction signal to the controller;

wherein the induction component is mounted at the charging port, and acquires a corresponding induction signal when the metal joint of the charging cable approaches the charging port, optionally, the induction component may be various kinds of sensors, for example, an infrared sensor or electromagnetic induction sensor.

In Step 530, the controller activates a magnetic attraction apparatus when determining that the induction signal meets a first preset condition; and

wherein the meeting a first preset condition may mean that a distance between the charging port and the metal joint of the charging cable is less than a first distance threshold, or that the intensity of the induction signal between the induction component and the metal joint of the charging cable is greater than a first induction signal threshold. Wherein that the meeting a first preset condition means that the induction signal between the charging port and the metal joint of the charging cable is greater than a first induction signal threshold may mean that:

when the user is ready for performing a charging operation, the metal joint of the charging cable approaches the charging port, and the induction component acquires an induction signal between the induction component and the metal joint of the charging cable, and sends the induction signal to the controller. The controller compares the received induction signal with the first induction signal threshold, determines that the user is about to charge the terminal device when the induction signal is greater than the first induction signal threshold, in this way, activates the charging guide component, and increases the intensity of electromagnetic field of the magnetic attraction apparatus, so as to attract the metal joint of the charging cable into the charging port, for example, the charging guide component is a magnetic attraction apparatus. Similarly, the magnetic attraction apparatus in this step may be reused as an electromagnetic induction component, in this way, when the magnetic attraction apparatus serves as the electromagnetic induction component in an initial state, the applied current may be relatively small; and when the controller judges that the induction signal meets a second preset condition, the current of the magnetic attraction apparatus is increased.

In Step 540, the controller deactivates the magnetic attraction apparatus when determining that the induction signal meets a second preset condition;

wherein the meeting a second preset condition may mean that the distance between the charging port and the metal joint of the charging cable is less than a second distance threshold, or that the intensity of the induction signal between the induction component and the metal joint of the charging cable is greater than a second induction signal threshold, or that the controller receives a signal indicating that the terminal device is being charged. When the second preset condition is met, the magnetic attraction apparatus may be deactivated. Certainly, when the magnetic attraction apparatus and the electromagnetic induction component are reused, deactivating the magnetic attraction apparatus may be understood to mean that a certain current is stilled applied to it so as to enable it to meet a use requirement of the electromagnetic induction component.

A technical solution provided by the fifth embodiment of the present disclosure realizes, by disposing the controller inside the terminal device and disposing the induction component and the charging guide component at the periphery of the charging port, guiding when the metal joint of the charging cable is inserted into the charging port. In addition, by disposing the mode selection mode, the user may select the magnetic attraction mode to work. By setting the second preset condition, the controller deactivates the magnetic attraction apparatus when determining that the second preset condition is met according to the induction signal, and thus the power consumption may be reduced.

It is noted that the foregoing is merely illustrative of preferred embodiments of the present disclosure and the applied technical principle. It will be appreciated to those skilled in the art that the present disclosure is not limited to the embodiments described herein, but may include more other equivalent embodiments without departing from the concept of the present disclosure.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make the corresponding technical solutions depart from spirits and scope of technical solutions of various embodiments.

What is claimed is:

1. A terminal device, comprising:
a charging port disposed on a housing of the terminal device,
a controller disposed inside the terminal device, and
an induction component and a charging guide component which are disposed at a periphery of the charging port; wherein
the induction component is electrically connected with the controller, and is configured to acquire an induction signal between the induction component and a metal joint of a charging cable and send the induction signal to the controller; and
the controller is also electrically connected with the charging guide component and is configured to activate the charging guide component when the induction signal meets a first preset condition.

2. The terminal device according to claim 1, wherein the controller is further configured to deactivate the charging guide component when the induction signal meets a second preset condition.

3. The terminal device according to claim 2, wherein the charging guide component comprises an indicator light disposed at the periphery of the charging port and/or a magnetic attraction apparatus disposed at the periphery of the charging port,
wherein the indicator light is used for being activated to be a guide to insert the metal joint of the charging cable into the charging port, and the magnetic attraction apparatus is used for attracting the metal joint of the charging cable into the charging port by increasing a magnetic force of an electromagnet at the charging port.

4. The terminal device according to claim 3, further comprising:
a user interface, which is electrically connected with the controller and is configured to receive a mode selection signal and send the mode selection signal to the controller, and the controller activates the indicator light or magnetic attraction apparatus according to the mode selection signal when the induction signal meets a first preset condition.

5. The terminal device according to claim 3, wherein the induction component is an electromagnetic induction component or an infrared induction component.

6. The terminal device according to claim 5, wherein the electromagnetic induction component is reused as the magnetic attraction apparatus.

7. The terminal device according to claim 1, wherein the induction component and the charging guide component are disposed on an inner wall of the charging port or at two sides of the charging port.

8. The terminal device according to claim 2, wherein
the first preset condition comprises a distance between the charging port and the metal joint of the charging cable is less than a first distance threshold, or that the intensity of an induction signal between the induction component and the metal joint of the charging cable is greater than a first induction signal threshold; and
the second preset condition comprises a distance between the charging port and the metal joint of the charging cable is less than a second distance threshold, or that the intensity of an induction signal between the induction component and the metal joint of the charging cable is greater than a second induction signal threshold, or that the controller receives a signal indicating that the terminal device is being charged.

9. A charging method based on the terminal device according to claim 1, comprising:
acquiring, by the induction component, the induction signal between the induction component and the metal joint of the charging cable, and sending the induction signal to the controller; and
activating, by the controller, the charging guide component when determining that the induction signal meets the first preset condition.

10. The method according to claim 9, further comprising:
deactivating, by the controller, the charging guide component when determining that the induction signal meets a second preset condition.

11. The method according to claim 10, when the charging guide component comprises an indicator light and a magnetic attraction apparatus, the method further comprises:
receiving, by a user interface, a mode selection signal and sending the mode selection signal to the controller; and
the activating, by the controller, the charging guide component when determining that the induction signal meets a first preset condition comprises:
activating, by the controller, the indicator light or magnetic attraction apparatus according to the mode selection signal when determining that the induction signal meets the first preset condition.

12. The method according to claim 10, wherein the first preset condition comprises a distance between the charging port and the metal joint of the charging cable is less than a first distance threshold, or that the intensity of an induction signal between the induction component and the metal joint of the charging cable is greater than a first induction signal threshold; and
the second preset condition comprises a distance between the charging port and the metal joint of the charging cable is less than a second distance threshold, or that the intensity of an induction signal between the induction component and the metal joint of the charging cable is greater than a second induction signal threshold, or that the controller receives a signal indicating that the terminal device is being charged.
